(19) United States
(12) Patent Application Publication
(10) Pub. No.: US 2005/0113552 A1
(43) Pub. Date: May 26, 2005

(54) Method for making an aqueous coating with a solid crosslinking agent

(76) Inventor: Charles L. Tazzia, Grosse Pointe Farms, MI (US)

Correspondence Address: BASF CORPORATION;ANNE GERRY SABOURIN, 26701 TELEGRAPH ROAD, SOUTHFIELD, MI, 48034-2442, US

(21) Appl. No.: 10/723,900

(22) Filed: Nov. 25, 2003

(51) Int. Cl. C08G 18/28

(52) U.S. Cl. 528/73

(57) ABSTRACT

An aqueous composition includes in dispersion an active hydrogen-functional resin and a uretdione compound. The uretdione compound is a crosslinker for the active hydrogen-functional resin. The uretdione compound does not release volatile by-products during the curing reaction, which reduces regulated emissions and increases the amount of coating solids weight converted to cured coating on the substrate. The aqueous dispersion coating may be made by combining a solid uretdione compound with a molten, water-dispersible resin, salting the water-dispersible resin if necessary, and dispersing the resin mixture in water. The molten, water-dispersible resin may have functionality reactive with the uretdione compound, or the coating composition may contain a further water-dispersible resin having functionality reactive with the uretdione compound. The coating composition of the invention is applied to a substrate and then cured to produce a cured coating layer on the substrate. In a particular embodiment, the coating composition of the invention is electrodepositable and is coated onto the substrate by electrodeposition.

### FIELD OF THE INVENTION

The invention relates methods for preparing of thermosetting aqueous coatings, especially to electrodepositable aqueous dispersions. In another aspect, the invention relates to crosslinking agents for coatings that react without releasing volatile by-products.

### BACKGROUND OF THE INVENTION

Aqueous coatings are used in a variety of applications in the automotive coatings industry. They advantageously provide reduced organic emissions, lower toxicity, and reduced fire hazard . The aqueous coatings are, in general, “dispersions” or two-phase systems of a finely divided solid or liquid in a continuous medium. As used herein, “dispersion” refers to two-phase systems of one or more finely divided solids, liquids or mixtures thereof, in a continuous liquid medium such as water or a mixture of water and organic cosolvent. “Emulsion” as used herein refers to a dispersion of liquid droplets in a liquid medium, preferably water or a mixture of water and various cosolvents.

Aqueous dispersions may be used as electrodeposition coatings, primers, sealers, basecoats, and/or topcoats. Various binders may be used in aqueous coating dispersions, including but not limited to, epoxy based resins, acrylic resins, polyester resins, alkyds, polyurethanes, polyurethane adducts, and the like. In the electrodeposition coating process, electrically charged coating particles are ‘plated’ or ‘deposited’ out of a aqueous dispersion onto a conductive substrate. Electrodeposition or “electrocoat” processes are advantageous both economically and environmentally, due to the high transfer efficiency of solid coating to substrate and low levels of organic solvent.

Electrodeposition coating compositions and methods are widely used in industry today. One of the advantages of electrocoat compositions and processes is that the applied coating composition forms a uniform and contiguous layer over a variety of metallic substrates regardless of shape or configuration. This is especially advantageous when the coating is applied as an anticorrosive coating onto a substrate having an irregular surface, such as a motor vehicle body. The even, continuous coating layer over all portions of the metallic substrate provides maximum anticorrosion effectiveness.

Electrocoat baths usually comprise an aqueous dispersion of a principal film-forming resin, such as an acrylic or epoxy resin, having ionic stabilization. For automotive or industrial applications for which hard electrocoat films are desired, the electrocoat compositions are formulated to be curable compositions. This is usually accomplished by including in the bath a crosslinking agent that can react with functional groups on the principal resin under appropriate conditions (such as with the application of heat) and thus cure the coating. During electrodeposition, coating material containing an ionically-charged resin having a relatively low molecular weight is deposited onto a conductive substrate by submerging the substrate in an electrocoat bath having dispersed therein the charged resin and then applying an electrical potential between the substrate and a pole of opposite charge, for example, a stainless steel electrode. The charged coating material migrates to and deposits on the conductive substrate. The coated substrate is then heated to cure the coating.

Many commercial electrocoating compositions employ polyisocyanate crosslinkers to react with hydroxyl or amine functional groups on the electrodeposited resin. This curing method provides desirable urethane or urea crosslink bonds, but it also entails several disadvantages. In order to prevent premature gelation of the electrodepositable coating compositions, the highly reactive isocyanate groups on the curing agent must be blocked. In the past, the isocyanate crosslinkers have been blocked with a compound such as an oxime, caprolactam, or an alcohol that unblocks and volatilizes during cure to provide the lowest temperatures for the unblocking and curing reactions. The volatile blocking agents released during cure can cause other deleterious effects on various coating properties, however, and increase organic emissions. There is thus a need for electrodepositable coating compositions and other aqueous coating compositions that could provide desirable urethane or urea crosslink linkages but that avoid the problems that now accompany compositions having polyisocyanate curing agents blocked with volatilizing agents.

### SUMMARY OF THE INVENTION

The present invention provides an aqueous composition that includes in dispersion an active hydrogen-functional resin and a uretdione compound. The uretdione compound is a crosslinker for the active hydrogen-functional resin. In describing the invention, “resin” is used to refer to polymeric, oligomeric, and monomeric materials that may be used with the uretdione crosslinker compound to preparing a cured coating film. The uretdione compound does not release volatile by-products during the curing reaction, which reduces regulated emissions and increases the amount of coating solids weight converted to cured coating on the substrate.

The invention further provides a method of making these aqueous dispersion coatings, having steps of combining a solid uretdione compound with a molten, water-dispersible resin, salting the water-dispersible resin if necessary, and dispersing the molten water-dispersible resin and uretdione compound mixture in water to produce a coating composition having very low content of volatile organic materials. The water-dispersible resin may have functionality reactive with the uretdione compound, or the coating composition may contain a further water-dispersible resin having functionality reactive with the uretdione compound.

A further method of making the aqueous dispersion coatings has steps of combining the solid uretdione compound with a water-dispersible resin and an organic solvent to make a uretdione-resin solution, salting the water-dispersible resin if necessary, dispersing the uretdione-resin mixture in water, and optionally removing the organic solvent by evaporation (with or without heat and/or vacuum) to produce a coating composition having very low content of volatile organic materials. Again, the water-dispersible resin may have functionality reactive with the uretdione compound, or the coating composition may contain a further water-dispersible resin having functionality reactive with the uretdione compound.

The invention also provides a method of coating a substrate in which the coating composition of the invention is applied to a substrate and then cured to produce a cured coating layer on the substrate. In a particular embodiment, the coating composition of the invention is electrodepositable and is coated onto the substrate by electrodeposition. The deposited coating layer is cured by reaction of the active hydrogen-functional resin with the uretdione compound.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### DETAILED DESCRIPTION OF THE PREFERRED EMBODIMENTS

The following description of the preferred embodiment(s) is merely exemplary in nature and is in no way intended to limit the invention, its application, or uses.

The uretdione compounds used in the aqueous coating dispersions of the invention are formed by condensing an aromatic diisocyanate in the presence of a phosphine or pyridine catalyst or an aliphatic diisocyanate in the presence of a hexamethyl phosphorous triamide catalyst. An oligomeric crosslinker is prepared by further reaction with a diol to provide a product comprising a structure of: 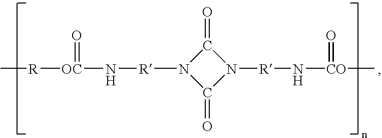
wherein R is the divalent residue of the diol, R′ is the divalent residue of the diisocyanate, and n is an integer of 1 to about 50. The product is a solid at room temperature. In other embodiments, n from 1 to about 20, more preferably from about 3 to about 16. Typically, the uretdione compound may have an equivalent weight of from about 250 to about 350.

The diisocyanate may be aromatic, aliphatic, and cycloaliphatic polyisocyanates and combinations thereof. Representative of useful diisocyanates are m-phenylene diisocyanate, 2,4-toluene diisocyanate, 2,6-toluene diisocyanate, mixtures of 2,4- and 2,6-toluene diisocyanate, hexamethylene diisocyanate, tetramethylene diisocyanate, cyclohexane-1,4-diisocyanate, any of the isomers of hexahydrotoluene diisocyanate, isophorone diisocyanate, any of the isomers of hydrogenated diphenylmethane diisocyanate, naphthalene-1,5-diisocyanate, 1-methoxyphenyl-2,4-diisocyanate, any of the isomers of diphenylmethane diisocyanate, including 2,2′-diphenylmethane diisocyanate, 2,4′-diphenylmethane diisocyanate, and 4,4′-diphenylmethane diisocyanate, isomers of biphenylene diisocyanate including 2,2′-, 2,4′-, and 4,4′-biphenylene diisocyanates, 3,3′-dimethoxy4,4′-biphenyl diisocyanate and 3,3′-dimethyl-diphenylmethane-4,4′-diisocyanate. In a preferred embodiment, the diisocyanate is isophorone diisocyanate.

Examples of suitable diols include, without limitation, ethylene glycol, diethylene glycol, and higher polyethylene glycol analogs like triethylene glycol; propylene glycol, dipropylene glycol, and higher polypropylene glycol analogs like tripropylene glycol; 1,4-butanediol, 1,3-butanediol, 1,6-hexanediol, and so on, as well as combinations of such diols. Uretdione oligomers are commercially available from Degussa Corporation, Downers Grove, Ill. for example Vestagon BF1350, and from Bayer Polymers LLC, Pittsburgh, Pa.

The aqueous coating composition further includes at least one an active hydrogen-functional resin. Active hydrogen groups reactive with isocyanate groups include, without limitation, hydroxyl groups, mercaptans, primary and secondary amines, amide groups with an active hydrogen, acid groups, and combinations of these. The active hydrogen-functional resin. To make the aqueous coating composition, the active hydrogen-functional resin is water-dispersible. Water-dispersible resins may contain ionizable groups that are salted to stably disperse the resin or may contain hydrophilic groups, e.g. polyethylene oxide moieties, to stably disperse the resin. A variety of such resins are known, including without limitation, acrylic polymers, other addition polymers, polyesters, epoxy resins, and polyurethane resins For electrocoat coating compositions, the resin is preferably cathodic, i.e., it has basic groups and is salted with an acid. In a cathodic electrocoating process, the article to be coated is the cathode. Water-dispersible resins used in the cathodic electrodeposition coating process have a cationic functional group such as primary, secondary, tertiary, and/or quaternary amine groups, quaternary sulfonium groups, or quaternary phosphonium groups as a positively chargeable hydrophilic group. Quaternary ammonium, sulfonium, and phosphonium groups are preferred. Waterborne topcoat compositions, such as clearcoat or basecoat compositions, preferably contain acrylic polymers or polyurethane polymers that are preferably anionic or nonionic.

In preferred embodiments, the uretdione crosslinker is at least about 5%, more preferably at least about 10% by weight of the nonvolatile vehicle. “Nonvolatile vehicle” refers to the film-forming components. It is also preferred for the uretdione crosslinker to be up to about 40%, more preferably up to about 30% by weight of the nonvolatile vehicle. The crosslinker is preferably from about 5% to about 40%, more preferably from about 10% to about 35%, and still more preferably from about 15% to about 35% by weight of the nonvolatile vehicle.

The coating composition may include a catalyst to enhance the cure reaction, for example, Lewis acids, zinc salts, and tin salts. An organic solvent or solvents may be utilized in the coating composition. In general, though, organic solvent is avoided to minimize organic volatile emissions from the coating process. Examples of useful solvents include, without limitation, ethylene glycol butyl ether, propylene glycol monomethyl ether acetate, xylene, N-methylpyrrolidone, propylene glycol phenyl ether, propylene glycol propyl ether, and so on.

When the coating composition is a primer composition or pigmented topcoat composition, such as a basecoat composition, one or more pigments and/or fillers may be included. Pigments and fillers may be utilized in amounts typically of up to 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like.

Additional agents, for example hindered amine light stabilizers, ultraviolet light absorbers, anti-oxidants, surfactants, stabilizers, wetting agents, rheology control agents, dispersing agents, adhesion promoters, etc. may be incorporated into the coating composition. Such additives are well-known and may be included in amounts typically used for coating compositions.

In one method, the coating composition is prepared by combining a solid uretdione compound with a molten, water-dispersible resin, salting the water-dispersible resin if necessary, and dispersing the molten mixture of water-dispersible resin and uretdione compound in water. The molten, water-dispersible resin may be prepared without using organic solvents or may be polymerized with solvent that is removed (e.g., by vacuum distillation) before the uretdione compound is added. It should be noted that the resin may be molten at room temperature. The molten, water-dispersible resin may have functional groups reactive with the uretdione compound and/or the coating composition may contain another resin having functional groups reactive with the uretdione compound.

A further method of making the aqueous dispersion coatings has steps of combining the solid uretdione compound with a water-dispersible resin and an organic solvent to make a uretdione-resin solution, salting the water-dispersible resin if necessary, dispersing the uretdione-resin mixture in water, and optionally removing the organic solvent by evaporation (with or without heat and/or vacuum) to produce a coating composition having very low content of volatile organic materials. Preferably, substantially all of the organic solvent is removed. Again, the water-dispersible resin may have functionality reactive with the uretdione compound, or the coating composition may contain a further water-dispersible resin having functionality reactive with the uretdione compound.

Coating compositions can be coated on the article by any of a number of techniques well-known in the art. These include, for example, spray coating, dip coating, roll coating, curtain coating, and the like. For automotive body panels, spray coating is preferred. In a particular embodiment, the coating composition of the invention is electrodepositable and is coating onto the substrate by electrodeposition. The electrodeposited or applied coating layer is cured by reaction of the active hydrogen-functional resin with the uretdione compound to produce a cured coating layer on the substrate.

The coating composition can be applied onto many different substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured. For electrodeposition coating, the substrate is electrically conductive.

The coating composition may also be a clearcoat or basecoat of an automotive composite color-plus-clear coating. The clearcoat coating composition is generally applied wet-on-wet over a basecoat coating composition as is widely done in the industry. The coating compositions described herein are preferably subjected to conditions so as to cure the coating layers. Although various methods of curing may be used, heat-curing is preferred. Generally, heat curing is effected by heating at a temperature and for a length of time sufficient to cause the reactants to form an insoluble polymeric network. The cure temperature is usually from about 150° C. to about 200° C., and the length of cure is usually about 15 minutes to about 60 minutes. Heating can be done in infrared and/or convection ovens.

The invention is further described in the following examples. The examples are merely illustrative and do not in any way limit the scope of the invention as described and claimed. All parts are parts by weight unless otherwise noted.

### EXAMPLES

Preparation A. Resin Mixture.

A suitable reactor is charged with 894.5 parts by weight of the diglycidyl ether of bisphenol A, 396.0 parts by weight of bisphenol A, 18.8 parts by weight of an alkyl phenol, and 68.9 parts by weight of xylene. The contents of the reactor are blanketed with nitrogen and heated to 125° C. A solution of 1 parts by weight triphenyl phosphine in 5 parts by weight xylene is added. The temperature is held at 150° C. until the weight per epoxide is measured at 1050 grams per equivalent. Then, 98.7 parts by weight each DOWANOL PPH and DOWANOL Pn-P are added. The mixture is cooled to 116° C., and 182.8 parts by weight methyl isobutyl ketone are added. Next, a mixture of 151.9 parts by weight thiodiethanol, 126.4 parts by weight lactic acid (88%), and 126.4 parts by weight water is added and the contents of the reactor are mixed for three hours at 93-95° C. Finally, 70 parts by weight of isobutanol is added.

### Example 1

### Coating Composition of the Invention

An unpigmented emulsion was prepared by combining 423.5 parts by weight of Preparation A, 29.1 parts by weight of an ethoxylated bisphenol A, 159.9 parts by weight of VESTAGON BF1 350 (purchased from Degussa Corporation, Downers Grove, Ill.), and 1 part by weight of SURFYNOL 104 DPM (purchased from Air Products, Allentown, Pa.) and heating the mixture to 75° C. The mixture was held at that temperature with stirring until the VESTAGON BF1350 dissolved in the other ingredients. The mixture was then cooled to about 60° C. and 1186.5 parts by weight deionized water were slowly added to emulsify the resin mixture.

A pigmented coating composition was prepared by combining 769.3 parts by weight of the unpigmented emulsion, 1073.2 parts by weight deionized water, and 157.5 parts by weight of a gray pigment paste.

### Example 2

### Coating Composition of the Invention

An unpigmented emulsion was prepared by combining 423.5 parts by weight of Preparation A, 29.1 parts by weight of an PLURACOL P710 (from BASF Corporation), 159.9 parts by weight of VESTAGON BF1350, and 1 part by weight of SURFYNOL 104 DPM (purchased from Air Products, Allentown, Pa.) and heating the mixture to 75° C. The mixture was held at that temperature with stirring until the VESTAGON BF1350 melted and dissolved in the other ingredients. The mixture was then cooled to about 60° C. and 1186.5 parts by weight deionized water were slowly added to emulsify the resin mixture.

A pigmented coating composition was prepared by combining 1063 parts by weight of the unpigmented emulsion, 1838.9 parts by weight deionized water, and 240.5 parts by weight of a gray pigment paste.

The pigmented coating composition had a pH of 5.05 and was ultrafiltered to produce a conductivity of 803 micromhos. The coating composition was electrodeposited onto phosphated steel panels using a bath temperature of 110° F. and deposition voltage of 150 volts. The deposited coating was cured by baking at 375° C. for 30 minutes. The filmbuild was about 0.9 mils.

The description of the invention is merely exemplary in nature and, thus, variations that do not depart from the gist of the invention are intended to be within the scope of the invention. Such variations are not to be regarded as a departure from the spirit and scope of the invention.

1. An aqueous coating composition comprising a dispersion of an active hydrogen-functional resin and a uretdione compound.

2. An aqueous coating composition according to claim 1, wherein the uretdione compound comprises a structure of: 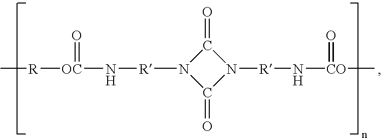
wherein R is a divalent alkylene radical, R′ is a divalent alkylene, cycloalkylene, arylene, or alkylarylene radical, and n is an integer of 1 to about 50.

3. An aqueous coating composition according to claim 2, wherein n is a sufficiently large number so that the compound is a solid at room temperature.

4. An aqueous coating composition according to claim 1, wherein the uretdione compound is a uretdione of isophorone diisocyanate.

5. An aqueous coating composition according to claim 1, wherein the coating composition is electrodepositable.

6. An aqueous coating composition according to claim 1, wherein the coating composition is cathodically electrodepositable.

7. A method of making an aqueous dispersion coating, comprising steps of combining a solid uretdione compound with a molten, water-dispersible resin to form a homogenous resin mixture;
salting the water-dispersible resin if necessary; and
dispersing the resin mixture in water.

8. A method according to claim 7, wherein the molten, water-dispersible resin has functionality reactive with the uretdione compound.

9. A method according to claim 7, wherein the coating composition contains a further water-dispersible resin having functionality reactive with the uretdione compound.

10. A method according to claim 7, wherein the water-dispersible resin has quaternary groups.

11. A method of coating a substrate, comprising
applying the coating composition of claim 1 to a substrate and
curing the applied coating composition to produce a cured coating layer on the substrate.

12. A method according to claim 11, wherein the coating composition is applied to the substrate by electrodeposition.
